(19) United States
(12) Patent Application Publication
(10) Pub. No.: US 2011/0173087 A1
(43) Pub. Date: Jul. 14, 2011

(54) OFFER AMALGAMATION SYSTEM

(76) Inventors: Stephen Dennis GIPPS, Queensland (AU); Colin Philip MILES, Queensland (AU)

(21) Appl. No.: 13/006,062

(22) Filed: Jan. 13, 2011

(30) Foreign Application Priority Data
Jan. 14, 2010 (AU) 2010900122

(51) Int. Cl. G06Q 30/00

(52) U.S. Cl. 705/26.3

(57) ABSTRACT

An offer amalgamating system receives offers for an item or service advertised for sale in differing quantities at differing prices and aggregates a display of the offers to provide to all offerers an indication as to when a price/quantity sale point is being approached. In this way an offerer may form part of an aggregated offer and receive the item or service at a lower cost than otherwise.

### TECHNICAL FIELD

The invention generally relates to systems in which goods or services are typically sold to the person making the highest offer.

More particularly the invention relates to an offering system in which the offering takes place in real time and in such a way that offers are amalgamated to gain price/quantity advantages.

### BACKGROUND OF THE INVENTION

The Internet is changing the way in which business is done. One of these changes is the shift in power from seller to buyer. Increasingly, buyers, whether consumers or businesses, are made aware of alternative sources of goods and services, and are able to leverage this knowledge to achieve better buying terms. Online comparison shopping services, such as PriceSpy, are good illustrations of this reality because they specialise in locating the cheapest price for specific goods. Because of the availability of these price comparison shopping services, other services have been made available for inviting buyers to quote prices. There are several conventional services, among the best known being priceline.com and ebay.com.au, which allow buyers to quote prices and invite sellers to accept the quote.

U.S. Pat. No. 5,794,207 relates to one such activity. This involves an aggregate conditional purchase offer (CPO) management system.

A further edge is afforded to buyers by their ability to assemble into online communities of interest, and leverage this network to their commercial advantage.

The notion of group buying and co-op buying has been explored and U.S. Pat. No. 6,604,089 describes one such system which makes reference to co-ops as a defined aggregate buying group. This aggregate buying mechanism has been earlier described with reference to prior patents and describes a method involving plural web portals (in order to aggregate sellers offers) and online organised buying groups or co-ops (in order to aggregate bids). A similar system is described in U.S. Pat. No. 7,124,099 in which electronic “deal rooms” are described.

Also of interest is an article “Should we collude? Analyzing the benefits of bidder cooperation in online group buying auctions” appearing in the January 2009 journal “Electronic Commerce Research and Application”.

Such systems fail to solve the problem of presenting a buyer with the lowest possible price when buying smaller quantities of items which are available in large numbers.

Therefore a need exists for a solution to the problem of providing a buyer with the lowest possible price for an item or service when other buyers may be contending for the same items.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in any country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in a buying system simultaneously offering different multiples of an item or service for sale, the price of the item or service being defined in relation to the number of the same item or service sold, recording bids from multiple potential buyers of the items or services, aggregating the quantities of the item or service requested by the multiple buyers, determining the defined price applicable to the aggregated quantity, displaying such multiple buyer bids to potential buyers and accepting bids from buyers which bids are greater than or equal to the defined price applicable to a one of the offered different multiples of an item or service for sale.

Preferably the item or service is sold to the bidders at the defined price matching the applicable price for an offered multiple of an item or service where the bidders offer exceeds that price.

Preferably the system provides visual feedback to the buyers and potential buyers on the individual and aggregated bids as the bids are placed.

Preferably the bids of an individual buyer may be displayed differently to the individual buyer than those of other bidders.

Preferably price and quantity of an item or service are displayed on differing axes of a display which also shows the sellers price/quantity parameters and the aggregated bids of the bidders in relation to the seller's parameters.

In an alternative embodiment the invention consists in a buying process simultaneously offering different multiples of an item or service for sale, the price of the item or service being set in relation to the number of the same item or service sold, recording bids from multiple potential buyers of the items or services, aggregating the quantities of the item or service requested by the multiple potential buyers, determining the set price applicable to the aggregated quantity, indicating to the multiple potential buyers the current aggregate quantity and applicable set price and potential other aggregate quantities and their corresponding set prices, indicating a time until the offer closes and accepting changes in ordered quantities until the offer closes.

Preferably aggregated offers equalling or exceeding the price applicable for a quantity will result in the purchase of that quantity when the offer closes.

In an alternative embodiment the invention consists in an item or service offer system offering multiples of an item or service and providing;
multiple quantity/price correspondences set by the seller for an item or service,
at least one buyer offer to buy a specific quantity of the item or service at a specific price,
a graphic portrayer displaying the price/quantity correspondence set by the seller and the price/quantity currently offered by the buyer(s),
an updater updating the graphic portrayal as buyer offers or the seller quantity/price correspondences alter,
an aggregator aggregating the quantities offered by multiple buyers at or above specific prices,
an offer acceptor activated when the quantity aggregated by the aggregator at or above a specific price equals or exceeds a seller set quantity/price correspondence.

Preferably the offer acceptor is activated only when a quantity aggregated by the aggregator at a specific price equals or exceeds a seller set quantity/price correspondence and a specific time has elapsed.

Preferably the offer acceptor is activated to accept the lowest price offer still equalling or exceeding a quantity/price correspondence set by the seller at the offer acceptance time.

These and other features of as well as advantages which characterise the present invention will be apparent upon reading of the following detailed description and review of the associated drawings.

### BRIEF DESCRIPTION OF THE DRAWINGS

FIG. 1 is a flow diagram of the buying process implemented by the system.

FIGS. 2 to 19 are views of a graphical interface to a buying process.

FIG. 20 is a diagrammatic view of the apparatus implementing the system.

### DESCRIPTION OF THE INVENTION

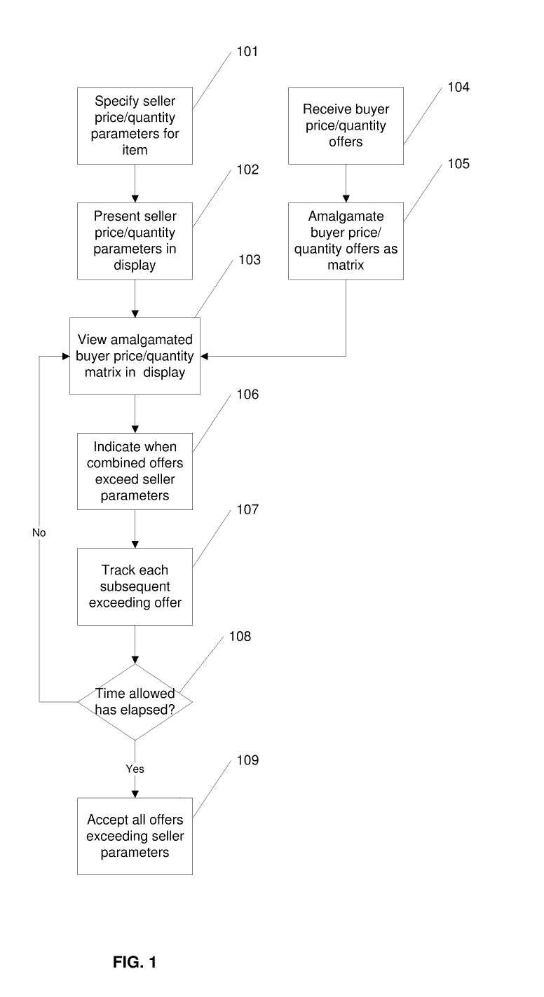

Referring now to FIG. 1 the system implements a process in which at 101 a seller specifies to the system the multiple price/quantity parameters for the sale of a number of the item or service concerned. Typically these take the form of a quantity, such as one, and the price which that quantity would be sold for, such as $25, a further quantity such as ten, and the price ten would be sold for, for instance $14. These set price/quantity parameters are presented at 102 in a display visible to any participating buyer so that the parameters are known to all buyers. The seller offers may be available for a limited time, ie the process may have some of the attributes of an auction.

Buyers may make an offer to buy at 104, and an amalgam of the buyer offers is created as a matrix at 105. A calculation engine extracts seller and buyer information relating to a single item and performs calculations based upon these to allow the presentation at 103 of a combined seller/buyer display. These offers may optionally be known as bids, depending on whether the system is considered as an auction or as a simple selling system.

The calculation engine creating the data for the display recognises when the combined offers of the buyers exceed the sellers set price/quantity parameters at some quantity and indicates this on the display at 106. Other offers may be made and may result in the set price/quantity parameters being met at a lower price on the seller's parameter list as at 107. Eventually the time available for offers times out at 108 and all combined offers equalling or exceeding the lowest of the sellers set price/quantity parameters which have been met are accepted at 109. It should be noted that because the offers are amalgamated a price offer at a higher price may be accepted at a lower price when it contributes to an amalgamated offer which equals the seller parameters at the lower price.

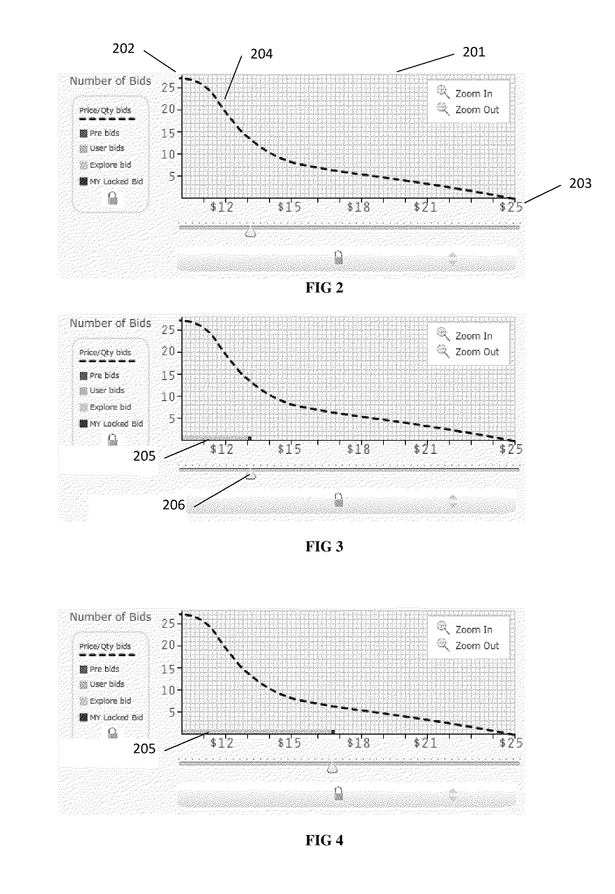

FIG. 2 shows one version of a graphical interface 201 for sellers which includes a quantity scale 202, a price scale 203 and a curve 204 picking out the price/quantity points of the sellers parameters.

FIG. 3 shows a bar 205 indicating a potential bid being explored by the buyer at the display. The length of the bar (price) is adjusted with slider 206. As FIGS. 4 and 5 show the bar may be moved to any price within the range shown.

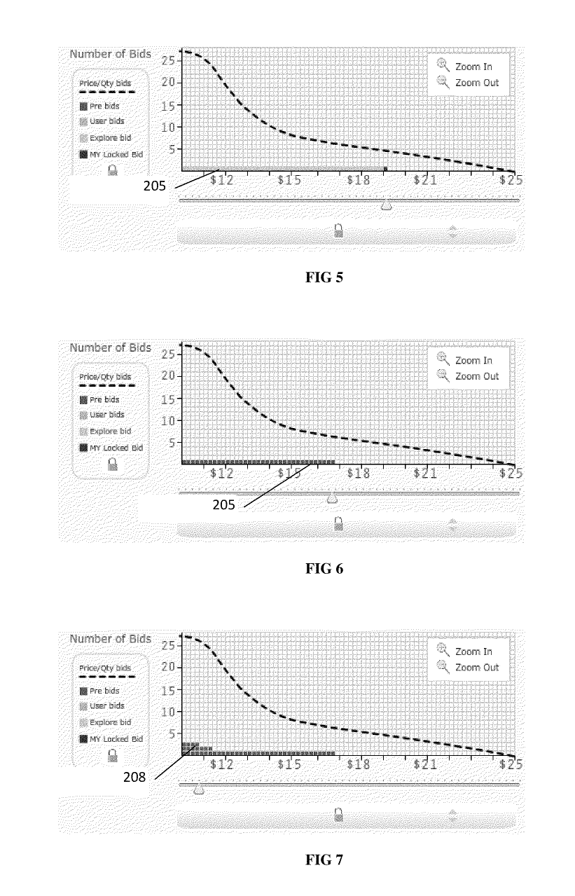

FIG. 6 shows a pre-live actual bid made by someone other than the bidder viewing the display as being set at $16.80. The auction is not yet featured live so the pre-live bid may be optionally binding or non-binding, depending on the system setup, although when the auction is opened (live) it will become a binding bid.

FIG. 7 shows two further pre-bids such as 208 which act to form a “stack” of bids.

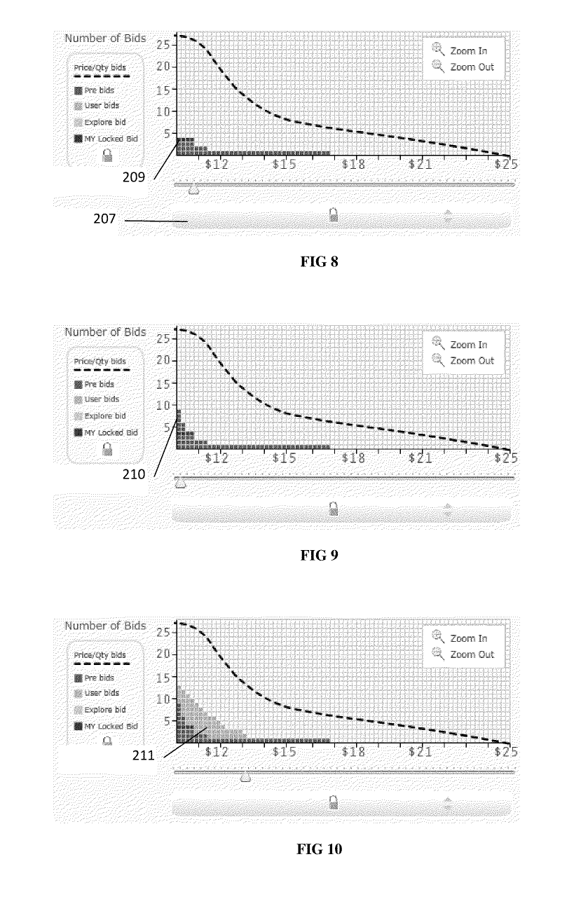

FIG. 8 shows further pre-live bids, and then a pre-live bid by the buyer viewing the display at 209 of $10.80. Button 207 has been clicked to set and confirm a pre-live bid at this price. FIG. 9 shows other pre-live bids 210 by other persons after the buyer at the display has created a pre-live bid.

FIG. 10 shows the situation after the auction becomes live. All bids 211 of other buyers as well as the current buyer bids are shown. This includes the previous retained pre-live bids as well as other actual bids taking place after the auction is opened. The colours in which the different types of bids are presented may differ to provide an easy indication to the potential buyer of the offer situation. As shown in FIG. 10 none of the cumulated total of bids reaches the seller curve so there are no potential sales present.

FIG. 11 indicates at 212 an addition to the buyers original locked bid of $10.80 by raising it to $11.60. The addition to the bid is displayed in time/price manner as being the latest bid to be received on the prices between $10.80 and $11.60. This allows the viewer to determine where the aggregated display is growing and where the viewer has contributed to the growth.

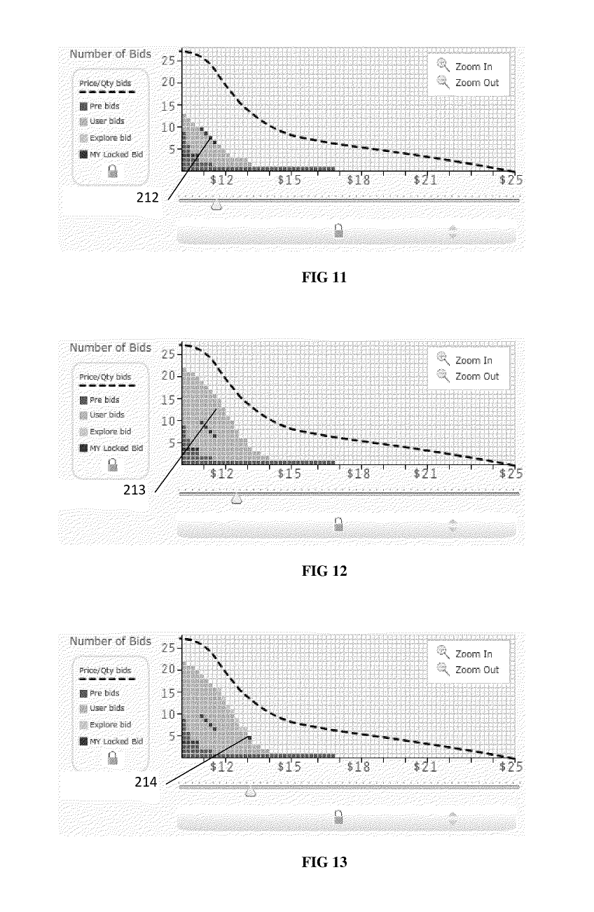

FIG. 12 indicates the overlay at 213 of the later $11.60 bid of the current buyer by other bids by other buyers.

FIG. 13 shows yet a further addition to the original bid by the current buyer to bring it to $13.20.

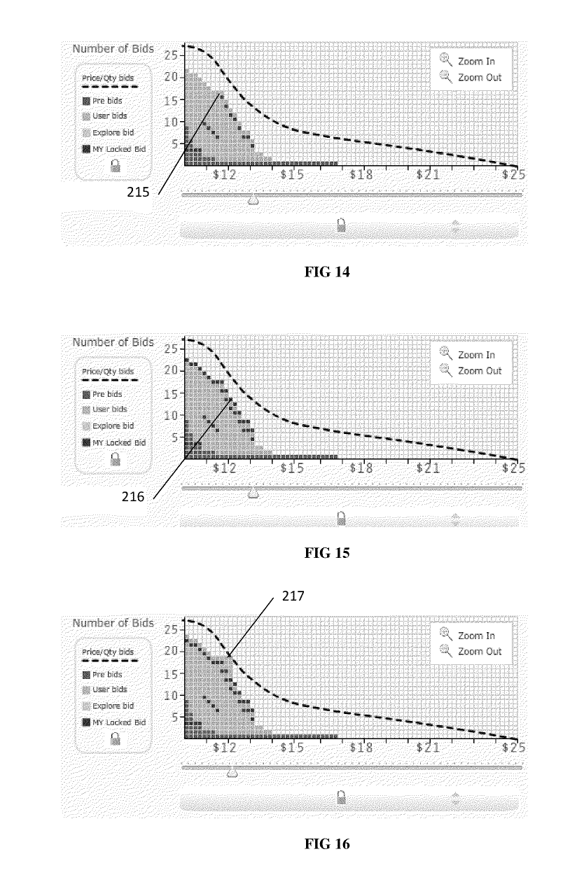

FIG. 14 indicates at 215 and elsewhere the overlay by other buyers of the current buyers latest bid.

FIG. 15 shows an additional volume by the current buyer at the same price as the increased original bid, showing that a second bid 216 is also highlighted to the current buyer.

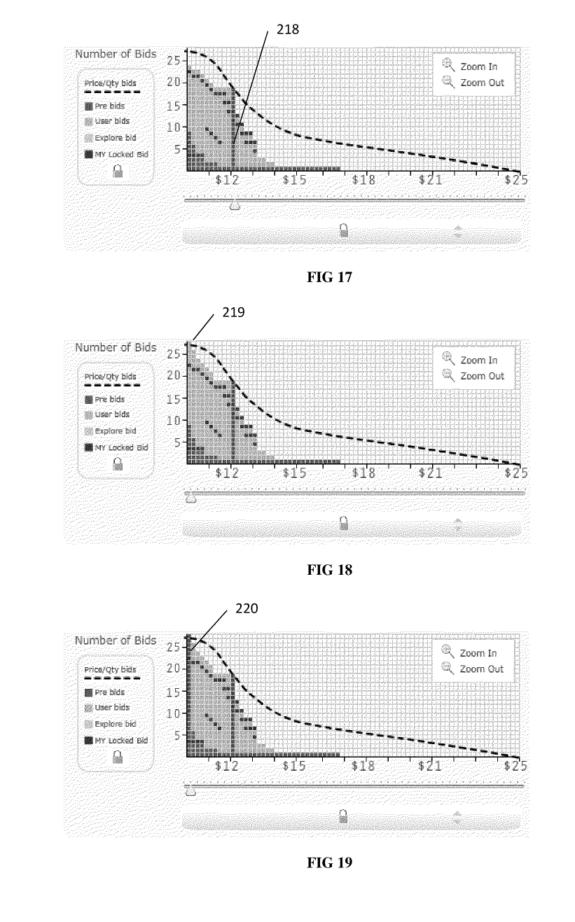

FIG. 16 shows further bids by other bidders which act to produce a price/quantity which reaches the sellers parameters at 217. Note that the single bid reaching the sellers price/quantity line is reflected into the quantities below it which may assist another buyer aiming at buying a lower final quantity. Point 217 is then highlighted in FIG. 17 by a bar 218 which indicates the highest price which will actually be charged to any buyer for the quantity they are currently bidding for (two for the current buyer). Other methods of indicating that bids have reached the sellers parameters may be used, for instance the display may flash.

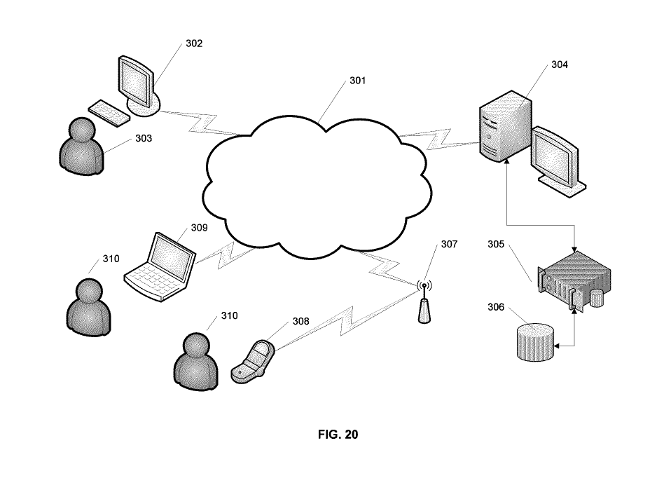

FIG. 18 shows at 219 the subsequent addition of lower value bids which cause the sellers parameters to be met at a lower price/higher quantity value. FIG. 19 indicates this with a second vertical bar 220 which indicates that all bidders will now be required to pay only $10 for their specified quantity, since the total quantity being sold has reached the 27 unit level.

While FIGS. 2 to 19 show one possible variation of a display to advise users of their offers and those of others making offers for the same item or service there are many other optional display variations which may display the same information to the buyers in such a manner that they can see the aggregate of the offers for the item or service, and how closely this aggregate approaches the parameters set by the seller. Equally there are many ways of controlling how bids are placed and what the value of a bid is, for instance rather than a slider controlled bid as shown in the drawings a bid may be set by a hovering mouse control, providing a more intuitive control system.

FIG. 20 indicates the apparatus of the invention. A seller 303 at a computer 302 sends via the internet 301 or any other network a series of price versus quantity parameters for a service or item via a web server 304 to a transaction server 305 with a database 306. The parameters are recorded in such a manner as to allow easy display of the parameters in a graphical manner.

Multiple bidders 310 may make offers on the service or item via computers such as 309 via the internet or mobile phones such as 308 via a mobile network 307 with access to the internet. These offers are recorded in the database 306 and may include the price, the quantities, and the time of the offer. The transaction server 305 which implements the calculation engine of FIG. 1 may then extract sufficient data from the database to return to computers 309 or phones 308 information displayable, for instance, as the graphics of FIGS. 2 to 19, though many other graphic displays carrying similar information content are possible. The relevant information is typically the closeness of the approach of the amalgamated offers to the seller's price/quantity parameters.

The bid/offer for the multiple services/items may take place over a set period of time such as one week or it may proceed until a single price point on the vendor's parameters is exceeded, or it may proceed until the vendor highest quantity is exceeded. Any one of these or other available options for deciding the term of the offer amalgamation may be decided upon by the seller.

The system may optionally allow a potential buyer to opt out of the ongoing amalgamation system by accepting the most recent lowest price break achieved, or may allow the potential buyer to take up progressively improving “buy now” price breaks at any time.

To summarise, in this way a buying process can be completed which cumulates the bids of all buyers and highlights where the cumulated bids reach the price/quantity parameters specified by the seller. The result is a reduced price for all buyers where the buyers act in concert although there is no requirement for the buyers to be members of a group, or to have any specific attributes to take part in such an aggregative bidding process. A progressively favourable “buy now” system may also be inherently built in to the process, which is an improvement on existing static ‘buy now’ offerings generally available at online auctions. Additionally there is an element of tactical buying present in that the visibility of the total bids to the potential buyer allows strategic bidding to try to trend the other buyers towards a series of bids which will reach the sellers price/quantity parameters.

It is noted that while no overt communication between buyers is part of the presently claimed invention there is some possibility of collusion if the buyers are aware of who is bidding. This may be seen as a feature of the system.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected.

For example the particular elements of the bid aggregating system may vary dependent on the particular application for which it is used without variation in the spirit and scope of the present invention.

In addition, although the preferred embodiments described herein are directed to a bid aggregating system for use in an auction type system, it will be appreciated by those skilled in the art that variations and modifications are possible within the scope of the appended claims.

### INDUSTRIAL APPLICABILITY

The bid aggregating system of the invention is used in the monitoring and confirmation of offers for goods or services and for the display of the aggregation of offers for those goods or services in a manner which enhances the user control of the buying process. The present invention is therefore industrially applicable.

1. A buying system simultaneously offering different multiples of an item or service for sale, the price of the item or service being defined in relation to the number of the same item or service sold, recording bids from multiple potential buyers of the items or services, aggregating the quantities of the item or service requested by the multiple buyers, determining the defined price applicable to the aggregated quantity, displaying such multiple buyer bids to potential buyers and accepting bids from buyers which bids are greater than or equal to the defined price applicable to a one of the offered different multiples of an item or service for sale.

2. A buying system, as claimed in claim 1 wherein the item or service is sold to the bidders at the defined price matching the applicable price for an offered multiple of an item or service where the bidders offer exceeds that price.

3. A buying system, as claimed in claim 1 wherein the system provides visual feedback to the buyers and potential buyers on the individual and aggregated bids as the bids are placed.

4. A buying system, as claimed in claim 1 wherein the bids of an individual buyer may be displayed differently to the individual buyer than those of other bidders.

5. A buying system, as claimed in claim 1 wherein price and quantity of an item or service are displayed on differing axes of a display which also shows the sellers price/quantity parameters and the aggregated bids of the bidders in relation to the seller's parameters.

6. A buying process simultaneously offering different multiples of an item or service for sale, the price of the item or service being set in relation to the number of the same item or service sold, recording bids from multiple potential buyers of the items or services, aggregating the quantities of the item or service requested by the multiple potential buyers, determining the set price applicable to the aggregated quantity, indicating to the multiple potential buyers the current aggregate quantity and applicable set price and potential other aggregate quantities and their corresponding set prices, indicating a time until the offer closes and accepting changes in ordered quantities until the offer closes.

7. A buying process as claimed in claim 6 wherein aggregated offers equalling or exceeding the price applicable for a quantity will result in the purchase of that quantity when the offer closes.

8. An item or service offer system offering multiples of an item or service and providing;
multiple quantity/price correspondences set by the seller for an item or service,
at least one buyer offer to buy a specific quantity of the item or service at a specific price,
a graphic portrayer displaying the price/quantity correspondence set by the seller and the price/quantity currently offered by the buyer(s),
an updater updating the graphic portrayal as buyer offers or the seller quantity/price correspondences alter,
an aggregator aggregating the quantities offered by multiple buyers at or above specific prices,
an offer acceptor activated when the quantity aggregated by the aggregator at or above a specific price equals or exceeds a seller set quantity/price correspondence.

9. An item or service offer system as claimed in claim 8 wherein the offer acceptor is activated only when a quantity aggregated by the aggregator at a specific price equals or exceeds a seller set quantity/price correspondence and a specific time has elapsed.

10. An item or service offer system as claimed in claim 8 wherein the offer acceptor is activated to accept the lowest price offer still equalling or exceeding a quantity/price correspondence set by the seller at the offer acceptance time.
